(19) United States
(12) Patent Application Publication
(10) Pub. No.: US 2010/0178235 A1
(43) Pub. Date: Jul. 15, 2010

(54) METHOD OF PRODUCING STABLE OXY-CHLORO ACID

(76) Inventors: Amit Gupta, Aurora, IL (US); E.H. Kelle Zeiber, Hixson, TN (US)

Correspondence Address: NALCO COMPANY, 1601 W. DIEHL ROAD, NAPERVILLE, IL, 60563-1198, US

(21) Appl. No.: 12/353,620

(22) Filed: Jan. 14, 2009

(51) Int. Cl. C01B 11/14; C01B 11/12

(52) U.S. Cl. 423/475; 423/472

(57) ABSTRACT

The invention is a method of producing stable chlorous acid for use as a cleaning agent and biocidal composition. The method passes a salt of an oxy-chloro acid over a resin to allow for an ion exchange that produced the oxy-chloro acid. The invention allows for the production of a stable chlorous acid that can be used as a biocidal agent and a cleaning agent without the effect on many surfaces or membranes as normal oxy-chloro compositions.

### COPYRIGHT NOTICE

A portion of the disclosure of this patent document contains or may contain copyright protected material. The copyright owner has no objection to the photocopy reproduction by anyone of the patent document or the patent disclosure in exactly the form it appears in the Patent and Trademark Office patent file or records, but otherwise reserves all copyright rights whatsoever.

### TECHNICAL FIELD

This invention relates to the production of stable chlorous acid for use as a biofouling control agent. The invention shows the method for production of chlorous acid in a stable form that allows for the production, storage and transportation of chlorous acid. The invention demonstrates the method of producing a stable and functional chlorous acid, which allows for the use of chlorous acid as biocidal composition and a cleaning agent without its rapid degradation into chlorine dioxide.

### BACKGROUND

The invention described here pertains to the automated production of a biofouling control agent. The basis for the production method is the use of ion exchange resins to convert a liquid solution from one chemical form to another less stable form.

Ion exchange is the reversible interchange of ions between a solid (ion exchange material) and a liquid in which there is no permanent change in the structure of the solid. Ion exchange is commonly used in water treatment and also provides a method of separation in many non-water processes. It has special utility in chemical synthesis, medical research, food processing, mining, agriculture and a variety of other areas.

Ion exchange has been in industrial use since circa 1910, with the introduction of water softening using natural and later, synthetic zeolites. Sulfonated coal, developed for industrial water treatment, was the first ion exchange material that was stable at low pH. Ion exchange reactions are reversible. By contacting a resin with an excess of electrolyte the resin can be converted entirely to the desired salt form. The ion exchange process involves diffusion through the film of solution that is in close contact with the resins and diffusion within the resin particle. The process of ion exchange is best understood with the example of the most common application, water softening. Water softening accounts for the major tonnage of resin sales. Hard waters, which contain principally calcium and magnesium ions, cause scaling, such as in water pipes, domestic cooking utensils, and also cause soap precipitation which forms an undesirable gray curd and a waste of soap. Water softening involves the interchange of hardness for sodium on the resin. Typically, hard water is passed through a bed of a sodium cation exchange resin where the calcium ions from the water are exchanged for sodium ions from the resin, thus softening the water. Following the passage of hard water through the ion exchange resins, the resins are gradually depleted of their sodium content and require regeneration to maintain the effectiveness of the softening process. Regeneration of the exchanger involves the passage of a fairly concentrated solution of sodium chloride through the resin, where the sodium ion displaces the hardness ions from the resin beads.

The manufacture of ion exchange resins involves the preparation of a cross-linked bead copolymer either as cation resins, or as anion resins. As the name suggests, the type of resin used in an application depends on whether exchange of cations or anions is desired. For the purpose of this invention, the discussion will be restricted to technology that enables the exchange of cations mediated by the ion exchange resins. The cation exchange resins can be sub-divided into weak acid or strong acid cation resins. The weak acid resins have a high affinity for the hydrogen ion and are therefore easily regenerated with strong acids. The acid-regenerated resin exhibits a high capacity for the alkaline earth metals associated with alkalinity and a more limited capacity for the alkali metals with alkalinity. No significant salt splitting occurs with neutral salts. However, when the resin is not protonated (e.g., if it is depleted or has been neutralized with a caustic solution), softening can be performed, even in the presence of a high salt background. Strong acid resins are characterized by their ability to exchange cations or split neutral salts and are useful across the entire pH range.

Common examples of ion exchange resins applications include processes such as water softening, as described above; dealkalization, where the alkalinity is removed from the water in addition to the softening process; demineralization, where the net effect is the removal of electrolytes (minerals such as Na, Ca, Mg, etc) and a yield of purified water; and other processes such as wastewater treatment, catalysis and chemical processing, pharmaceuticals and fermentation, to name a few. Among the various applications described, the process of demineralization is closest to the method described in this invention.

Ion exchange demineralization is a two-step process involving treatment with both cation and anion exchange resins. Water is passed first through a column of acid cation exchange resin that is in the hydrogen form to exchange the cation in solution, for example, Ca²⁺, Mg²⁺ and Na⁺, for hydrogen ions. The effluent is then passed over a column of anion exchange resin in the hydroxide form to replace anions in solutions, for example, Cl⁻, SO₄²⁻ and NO₃⁻, with hydroxide anions. The hydrogen ions from the cation resin neutralize the hydroxide ions from the anion resin, resulting in the removal of minerals and production of purified water.

In the invention described here, a chlorite or chlorate salt solution of an alkali earth metal is passed through acidified cation exchange resins under conditions that allow for the production of stable form of oxy-chloro acids. Through this process, the cation from the salt solution is exchanged for the proton from the acidified resin, resulting in an acid form of the anion. As a result of salt passage, the acidified resins are gradually depleted of their acid (proton) content and require regeneration or re-acidification with an acid solution. Thus, this aspect of the described invention utilizes only the earlier half of the full demineralization process, and has been well documented in the scientific literature.

Despite the long history of ion exchange use, it is perceived that references to under conditions that allow for the production of stable form of oxy-chloro acids and monitoring for the specifics of production methods is lacking.

### SUMMARY

The current invention describes the following key aspects:
1. It is an advantage of the invention to provide an oxy-chloro species that has utility as a biofouling control agent.
2. It is an advantage of the invention to produce a stable form of the product that is storable and transportable
3. Provides a method for effective monitoring of the product quality.
4. Provides for a method of consistent production and quality control.

### DETAILED DESCRIPTION

The invention relates to a method for producing stable oxy-chloro biofouling control agent where in a salt of the oxy-chloro acid and a solvent are passed through an activated resin bed at a low concentration to produce a stable oxy-chloro acid at a pH of 2.5 or below.

The preferred salt of the oxy-chloro acid is a chlorite or chlorate with the most preferred being sodium chlorite or chlorate. The method feeds the salt of the oxy-chloro acid into the resin bed at a concentration of 1500 ppm or lower and producing the oxy-chloro acid with a pH no less than 2.2. The invention further may include a solvent being passed through the resin bed with the salt of the oxy-chloro acid. The preferred solvent for use in the invention is a solution of alkali or alkaline earth salts and water or water alone.

The resin in the resin bed of the invention is composed of a cation exchange resin. The preferred product of the method is chlorous acid, which is converted from the oxy-chloro acid. The production quality of the chlorous acid is measured by spectral absorbance using a spectrophotometric device wherein the measured absorbance determines the percentage of chlorous acid in the composition. The spectrophotometric device in the invention is placed in the resin bed where the salt of the oxy-chloro acid is passed through to become the chlorous acid.

### EXAMPLES

The foregoing may be better understood by reference to the following examples, which are intended to illustrate methods for carrying out the invention and are not intended to limit the scope of the invention.

### Example 1

A chlorite salt solution of an alkali earth metal is passed through acidified cation exchange resin such that the cation from the salt solution is exchanged for the proton from the acidified resin and results in the formation of an acid form of the anion. The resulting acid solution of the anion is a solution of stabilized chlorous acid that is generated at a pH of 2.3. It is known that chlorous acid is an intermediate between the chlorite solution and the formation of chlorine dioxide. Therefore, the quality of the produced product was monitored spectroscopically to understand the formation, and its extent, of chlorous acid. The spectral properties of chlorous acid was specific and did not carry any interference from chlorine dioxide. The spectroscopic measurements were used to calculate the concentration of chlorous acid, separate from other oxy-chloro species. The absorbance measurements showed that indeed chlorous acid was formed and there was little or no chlorine dioxide present. When the produced chlorous acid solution was spiked with a solution of pure chlorine dioxide, a measurement separate from chlorous acid could be made spectroscopically for chlorine dioxide.

### Example 2

A solution of stabilized chlorous acid was generated at a pH of 2.3. The quality of the produced product was monitored spectroscopically. The spectral measurements were used to calculate the concentration of chlorous acid, separate from other oxy-chloro species and were followed over time to estimate the proportion of the solution in each state. The table below shows that the majority of the species remain in the chlorous acid (HClO₂) form (˜80%) even after more than 2 hours in solution. In addition, it can be seen that only about 15% of the solution converted to ClO₂ under the experimental conditions (drop from 92 to 77% of total composition).

| | |
|---|---|
| HClO₂ | ClO₂ |

| Minutes | PPM | % | PPM | % |
|---|---|---|---|---|
| 0 | 645 | 92 | 54 | 8 |
| 30 | 626 | 88 | 87 | 12 |
| 49 | 621 | 85 | 107 | 15 |
| 79 | 601 | 81 | 137 | 19 |
| 132 | 568 | 77 | 172 | 23 |

It should be understood that various changes and modifications to the presently preferred embodiments described herein will be apparent to those skilled in the art. Such changes and modifications can be made without departing from the spirit and scope of the invention and without diminishing its intended advantages. It is therefore intended that such changes and modifications be covered by the appended claims.

We claim:

1. A method for producing a stable oxy-chloro biofouling control agent where in a salt of the oxy-chloro acid and a solvent are passed through an activated resin bed at a low concentration to produce a stable oxy-chloro acid at a pH of 2.5 or below.

2. The method of claim 1 wherein the salt of the oxy-chloro acid is a chlorite.

3. The method of claim 1 wherein the salt of the oxy-chloro acid is a chlorate.

4. The method of claim 2 wherein the chlorite is sodium chlorite.

5. The method of claim 3 wherein the chlorate is sodium chlorate.

6. The method of claim 1 wherein the concentration of the salt of the oxy-chloro acid is fed into the resin bed at a concentration of 1500 ppm or lower.

7. The method of claim 1 wherein the oxy-chloro acid is produced with a pH no less than 2.2.

8. The method of claim 1 wherein the solvent is solution of alkali or alkaline earth salts and water.

9. The method of claim 1 wherein the solvent passed through the resin bed with the salt of the oxy-chloro acid is water.

10. The method of claim 1 wherein the resin in the resin bed is composed of a cation exchange resin.

11. The method of claim 1 wherein the oxy-chloro acid produced is Chlorous acid.

12. The method of claim 11 wherein the production quality of the chlorous acid is measured spectroscopically wherein the measured spectra determines the percentage of chlorous acid in a composition.

13. The method of claim 12 wherein the spectrophotometric device is in the resin bed where the salt of the oxy-chloro acid is passed through to become the chlorous acid.
